(19) United States
(12) Patent Application Publication
(10) Pub. No.: US 2017/0116572 A1
(43) Pub. Date: Apr. 27, 2017

(54) SYSTEMS AND METHODS FOR DELIVERING GOODS TO CONSUMERS

(71) Applicant: Wal-Mart Stores, Inc., Bentonville, AR (US)

(72) Inventors: Chandrashekar Natarajan, San Ramon, CA (US); Donald R. High, Noel, MO (US); Dhaval Gat, Bangalore (IN)

(21) Appl. No.: 15/297,256

(22) Filed: Oct. 19, 2016

Related U.S. Application Data
(60) Provisional application No. 62/244,823, filed on Oct. 22, 2015.

(51) Int. Cl. G06Q 10/08; G06Q 30/06; G06Q 20/20; G06K 7/10

(52) U.S. Cl. CPC G06Q 10/0875; G06K 7/10009; G06Q 30/0633; G06Q 20/202

(57) ABSTRACT

A system for purchasable item delivery comprises an electronic device at a storage area of a first store customer wherein items purchased by the first store customer are temporarily stored after receipt from a retail establishment, and are available for purchase from the first store customer by a second store customer, the electronic device collecting data regarding the items; and a last mile system that processes the data to track an inventory of the items, and determines whether an item in the inventory of items is available for the second store customer from the storage area of the first store customer. The last mile system comprises: a device manager that monitors a location of the items at the at least one storage area; and an inventory management unit that monitors an inventory of the stored items at least at one of the at least one storage area of the first store customer or at the retail establishment.

### RELATED APPLICATIONS

This invention claims priority to U.S. provisional patent application Ser. No. 62/244,823, filed Oct. 22, 2015, entitled “Systems and Methods for Delivering Goods to Consumers”, which is included entirely herein by reference.

### FIELD

The present concepts relate generally to supply chain management, and more specifically, to systems and methods for delivering goods to a consumer in a final stage of a supply chain.

### BACKGROUND

A typical retail supply chain includes a linear flow where a supplier delivers goods to a warehouse. The goods can be delivered from the warehouse to a brick-and-mortar store, from where a consumer may purchase the goods. Alternatively, the goods can be shipped directly from the warehouse to a consumer's home or business in cases where the consumer purchases the goods from an online merchant.

### BRIEF SUMMARY

In accordance with one aspect, provided is a system for purchasable item delivery comprising: an electronic device at a storage area of a first store customer wherein items purchased by the first store customer are temporarily stored after receipt from a retail establishment, and are available for purchase from the first store customer by a second store customer, the electronic device collecting data regarding the items; and a last mile system that processes the data to track an inventory of the items, and determines whether an item in the inventory of items is available for the second store customer from the storage area of the first store customer.

In some embodiments, the last mile system comprises: a device manager including an Internet of Things (IoT) device that monitors a location of the items at the at least one storage area; and an inventory management unit that monitors an inventory of the stored items at least at one of the at least one storage area of the first store customer or at the retail establishment.

In some embodiments, the items include RFID devices that relay off beacon readers positioned in the at least one storage area for tracking the items.

In some embodiments, the inventory management unit processes data regarding shelf life, inventory movement, replenishment, recalls, and/or returns to track the inventory of the purchasable items in the at least one storage area of the first store customer.

In some embodiments, the inventory management unit comprises a scanner for detecting a stock of the items as part of the inventory.

In some embodiments, the last mile system comprises: a reputation integrity management system that performs an integrity check with respect to the first store customer; an agent onboarding engine that uses at least one of a social profile, background check, or credit check to validate the integrity of the first store customer; a goods status monitor that updates a list of inventory at the storage area if a determination is made of a product recall, damaged inventory items, identified returns, or other situations that may cause a change in inventory levels; and an order processor that generates a replenishment order when the inventory drops below a predetermined threshold at the storage area or the retail establishment.

In some embodiments, the reputation integrity management system performs social personal profiling.

In some embodiments, the items are protected by a background check or video analytics.

In some embodiments, the agent onboarding engine ensures selection of the first store customer by using the social profiling, background, or credit check results produced by the reputation integrity management system, and validating the first store customer through related web services.

In some embodiments, the order processor communicates with a point of sale (POS) system for receiving customer order information for updating a data record that includes data on the inventory.

In some embodiments, the order processor communicates with an inventory management unit to determine which storage location among a plurality of storage locations has an item of interest for fulfilling an order.

In some embodiments, the second store customer is downstream in a retail supply chain from the first store customer.

In some embodiments, a first portion of the inventory of the items is for the first store customer and a second portion of the inventory of the items is for the second store customer.

In some embodiments, the first and second store customers are each store customers, and wherein the first store customer does not purchase items at the store for resale to the second store customer.

In some embodiments, the at least one storage area comprises at least one appliance for at least one of storing, maintaining, or dispensing the items for the second store customer and the electronic device collects data from the at least one appliance.

In some embodiments, the at least one appliance communicates with an inventory management unit regarding inventory usage and restocking.

In some embodiments, the at least one storage area includes at least one of a freezer unit, a cooling unit, or a heating unit, or other device controlling an ambient temperature.

In some embodiments, the inventory or purchasable items in the at least one storage area of the first store customer is consumed by a combination of the first store customer and the second store customer.

In accordance with another aspect, a system for managing a delivery of goods to a consumer in a final stage of a supply chain comprises an inventory management unit that monitors an inventory of items stored at a storage area of a first store customer or at a retail establishment providing the inventory of items to the first store customer, and determines whether an item in the inventory of items is available for a second store customer from the storage area of the first store customer; a goods status monitor that updates a list of inventory at the storage area if a determination is made of a product recall, damaged inventory items, identified returns, or other situations that may cause a change in inventory levels; and an order processor that generates a replenishment order when the inventory drops below a predetermined threshold at the storage area or the retail establishment.

In some embodiments, the system further comprises a device manager that tracks and locates the items in or proximal the storage area of the first customer.

In some embodiments, the device manager includes an Internet of Things (IoT) device.

In some embodiments, the system further comprises a reputation integrity management system that performs an integrity check with respect to the first store customer; and an agent onboarding engine that uses at least one of a social profile, background check, or credit check to validate the integrity of the first store customer.

In accordance with another aspect, a method for delivering store items to a customer, comprises storing an inventory of purchasable items at a plurality of warehousing customer locations, each warehousing customer location receiving store items from a store; receiving an order for a store item from a new customer; monitoring by an electronic device at the warehousing customer location in communication with a last mile system that determines availability and viability of the items; receiving an order for a store item from a new customer; determining a closest warehousing customer location; and delivering the store item from the closest warehousing customer location to the new customer.

In some embodiments, the method further comprises contacting a delivery provider to deliver the identified inventory items from the identified warehousing customer location to the new customer.

In some embodiments, the deliverer may be a person at the warehousing customer location.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a diagram of an environment in which embodiments may be practiced.

FIG. 2 is a block diagram of a warehousing customer (WC) storage location, in accordance with some embodiments.

FIG. 3 is a block diagram of a last mile system (LMS) in accordance with some embodiments.

FIG. 4 is a diagram illustrating a method for delivering goods to a consumer's location, in accordance with some embodiments.

### DETAILED DESCRIPTION

The last leg of a retail supply chain includes the segment of the chain where manufactured goods are presented to the consumer or related acquirer of products of interest, either by the consumer purchasing the goods at a retail establishment where the goods are displayed, or by the goods being delivered directly to the consumer's home or business, or “last mile.” Regardless of whether goods are purchase at a store or delivered to a consumer's home or business, delivery-related issues may occur, such as exposure of the goods to possible theft or damage when the goods are left unattended, or safety issues when delivering the goods to the consumer.

The evolving landscape of e-commerce is increasing in popularity, and has rendered ineffective the linear flow model of conventional supply chains, where each location in the flow (i.e., supplier, warehouse, store, consumer) where each location acts on one step in the process. Accordingly, retail establishments are considering the use of customers as part of the supply chain, where each store functions as a warehouse. This logistics model may adapt to e-commerce applications.

In brief overview, embodiments include systems and methods for providing last mile services from a location under the ownership and/or control of a consumer, referred to as a warehousing customer (WC), and that serves as a temporary storage facility for purchased goods, to a final destination of the goods in the retail supply chain, such as a new customer, end user, or other receiver, owner, and/or user of the purchased goods. In some embodiments, the foregoing is achieved by applying a crowdsourcing model in order to deliver goods during the “last-mile” phase of the fulfillment process. The WC location can be a garage, shed, warehouse, or other facility or region of a facility that is outfitted with appliances, equipment, or other elements necessary for temporarily warehousing the goods. The WC location can include electronic communications devices that provide information to a special-purpose computer, which can remotely track, process, and analyze inventory, temperature conditions, replenishment or replacement needs, and so on at the WC location, and determine delivery options from the WC location to the final destination of the goods stored at the WC location, for example, based on the location of the new customer.

In some embodiments, the goods at the final leg of delivery are protected by a reputation integrity management system, which performs integrity checks with respect to the WC location. The goods may also be protected by a background check to ensure security. RFID tags that communicate with beacon readers and video analytics may also be used for protecting goods.

The reputation integrity management system can perform social personal profiling, using for example, social media, performing background checks, credit checks, and so on. An intelligent agent onboarding engine can ensure vendor/agent selection by using the social profiling, background, or credit check results produced by the reputation integrity management system, and validate the WC through related web services. Once these checks are performed, and the WC location deemed to be a geographically acceptable location, the WC may be approved for serving as a warehouse for store items. For example, a consumer who wishes to allow products to be stored in the consumer's home must pass all defined tests. The consumer may be required to sign release form enables the service provider to initiate a background, and credit check along with a full blown internet check to ensure all aspects of accountability.

During operation, a user may register with a service, whereby is provided that permits the system to perform a check. Here, the system, may execute an API call for a background check and credit check. Once the user is cleared, the system can check the GPS of the WC to compare the demographics data base that establishes whether the established region is acceptable for the WC. In some embodiments, GPS coordinates may be used to execute an image analysis by a unmanned air vehicle (UAV), drone, satellite, or related device.

Crowdsourcing may be applied to the last-mile delivery by providing delivery from one customer, i.e., the WC, to another customer, i.e., the NC, which can reduce shipping costs while also providing improved shipping times. In some embodiments, crowdsourcing is applied by systems and methods by locating a product in close proximity to a new customer, and using a delivery person such as a third-party driver, or using the WC to deliver the product to the new customer, or to other people of interest, such as a purchasing customer other than a new customer.

The WC can be paid for renting out space for storing the goods. Retailers do not require a fleet of trucks or network of warehouses in order to achieve this. The WC can be paid for storing items for sale at the WC location according to multiple pricing structures, including but not limited to square footage of consumed space, time of storage, the frequency which the stored product is moved, flat rate, quality incentive, a percentage of sales, and so on.

Accordingly, the WC location at the home of one store customer may function as a “convenience store” or the like for providing store items to another store customer.

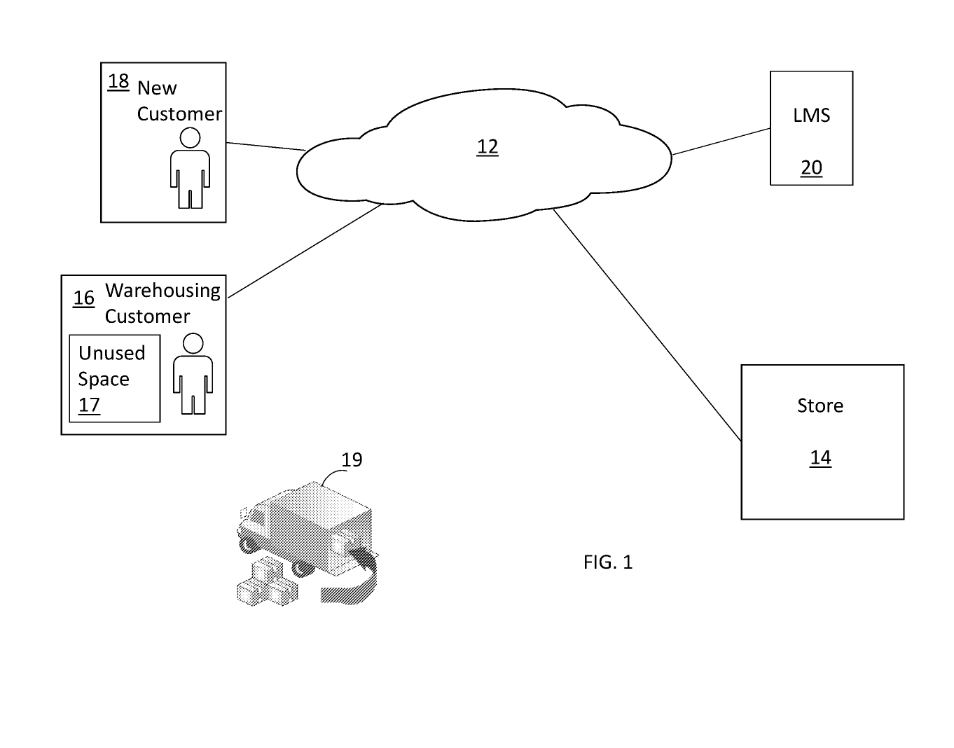

FIG. 1 is a diagram of an environment in which embodiments may be practiced. The environment may include store 14, a warehouse customer (WC) storage location 16, a new customer (NC) location 18, and a last mile system (LMS) 20. Each of the store 14, WC storage location 16, NC location 18, and LMS 20 may include at least one computer processor and network interface for communicating with each other and/or other electronic devices remove from the environment via a network 12. The network 12 may be a public switched telephone network (PSTN), a mobile communications network, a data network, such as a local area network (LAN) or wide area network (WAN), or a combination thereof, or other communication network known to those of ordinary skill in the art.

The store 14 is part of a retail supply chain, and may stock, ship, and/or sell goods to consumers, such as a home or business of a store customer, for example, WC storage location 16 and/or NC location 18. Accordingly, the NC location 18 may be downstream in a retail supply chain from the WC, which in turn is downstream in the retail supply chain from the store 14 or other retail establishment. In some embodiments, the store 14 may be a distribution center in communication with an online agent or e-commerce website, which delivers goods from the distribution center to a location identified by an online purchaser.

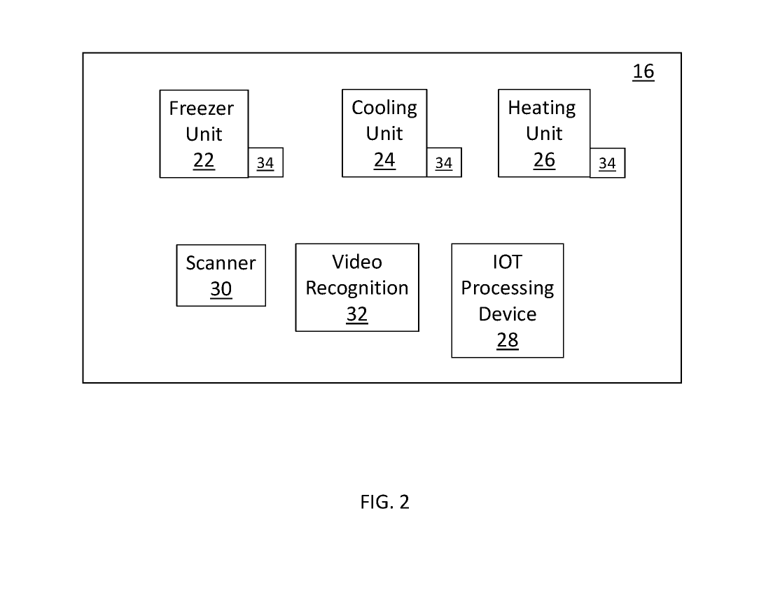

The WC storage location 16 includes a region 17, which may be an unused space or other area not occupied for other purposes where products received from the store 14 or other distribution facility can be temporarily stored, for a subsequent delivery to other customers such as NC location 18. This region 17 can be some or all of a garage, shed, or other location at a home or business, or any other dwelling or structure. As shown in FIG. 2, the WC storage location 16 may include one or more apparatuses, for example, plug-and-play appliances, for storing and processing the stored items. Examples may include but not be limited to a freezer unit 22, cooling unit 24, and heating unit 26, which may be part of the unused space 17. The freezer unit 22 may store produce or other items requiring storing temperatures at or below freezing. The cooling unit 24 can store produce, beverages, or other items requiring temperatures below room temperature, but above freezing temperatures, for example, chilled wine. The heating unit 26 may store items for hot dispensing, such as coffee, soup, ready-made dinners, and so on.

Each appliance, e.g., a freezer unit 22, cooling unit 24, and heating unit 26, may include an agent 34, or electronic device, that provides information to an Internet of Things (IoT) processing device 28, which in turn establishes an electronic communication with the LMC 16, for example, using radio frequency identification (RFID) or the like for exchanging data with the LMC 16. In other embodiments, the device agents 34 may establish an electronic communication directly with the LMS 20. Although the IoT processing device 28 is shown in FIG. 2 as being co-located at a WC location, in other embodiments, the IoT processing device 28 is at a remote location, and communicates with the electronic devices 34 via known communication media, such as wireless, Internet, and so on. The IoT processing device 28 and appliance agents 34 permit goods and/or apparatuses that store, maintain, or otherwise preserve the goods, for example, retail items, to be monitored and/or controlled by remote electronic devices via a network, including items requiring frequent replacement, replenishment, or upgrade, for example, perishables such as milk, meat, or vegetables, or everyday retail items such as razor blades, appliances, toilet paper, or printer cartridges. The IoT processing device 28 can process real-time information, such as usage patterns, item movement, device conditions, or activity, data on how much product is received, sold, or consumed, how much inventory is at the location, and so on.

One or more scanners 30 and/or other sensors can detect the presence of goods stocked at the WC storage location 16, for example, as inventory is placed at the WC storage location 16. A scanner 30 may be part of the LMS 20 as shown, or may be part of a beacon reader (not shown), or may be part of an electronic device 34. For example, a weight scale may be positioned on a shelf that holds a larger container of exotic imported coffee, which is sold in small quantities. The weight scale can determine a current weight of the coffee and provide weight information to the LMS 20 which in turn can establish a current inventory level of the coffee.

In some embodiments, RFID signals are generated from the RFID tags that are placed in the product's bar code. As RFID tags get closer to the scanner 30, they may emit a stronger signal, permitting a location of the item of interest to be triangulated. Bar codes or other tracking codes, magnetic ink, can be captured, or manually entered into the LMS 20 for tracking inventory, and/or output to other systems related to the management and distribution of goods to the WC storage location 16. The scanner 30 may continuously operate for tracking items in real-time.

The video recognition device 32 is positioned at the WC storage location 16 for capturing images, video, and/or sound of people who have access to the goods stocked at the storage location 16, for example, people who add or remove stock. The video recognition device 32 may output the captured data to the LMS 20 for processing. The LMS 20 may also use this data to determine item and/or WC integrity. The video recognition device 32 may also provide for quality control, inventory management, and/or asset protection.

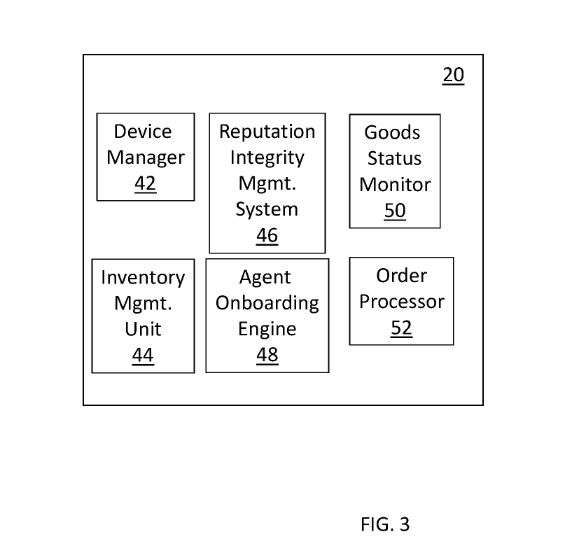

FIG. 3 is a block diagram of the LMS 20 of FIG. 1, in accordance with some embodiments. The LMS 20 can comprise a device manager 42, an inventory management unit 44, reputation integrity management system 46, an agent onboarding engine 48, a goods status monitor 50, and an order processor 52. Some or all of these elements of the LMS 20 may be present under a same computer hardware platform. In other embodiments, these elements may be located on two or more different computer hardware platform, and can communicate with each other and/or other elements of the system via a network 12 or other communication path, for example, wired or wireless signals. Although not shown, the LMS 20 may include at least one hardware processor and memory. One or more elements may be stored in memory and executed by a computer processor. Although not shown, the LMS 20 includes a network interface so that elements of the environment of FIG. 1 may communicate with electronic devices external to the LMS 20 via the network 12.

In some embodiments, the device manager 42 includes an IoT device that uses RFID signals or the like to track and locate items of interest. In some embodiments, the IoT device may be the same as an electronic device 34. In other embodiments, the IoT device may collect data from the electronic device 34. Usage data, restocking information, and so on may be communicated to the device manager 42 from the tagged items, for example, via the IOT processing device 28 at, or otherwise in communication with, the WC storage location 16. Cameras and/or other sensors may be used with video analytics to monitor the freezer unit 22, cooling unit 24, and ambient areas.

The inventory management unit 44 may use the inventory level data to establish when the WC storage location 16 may be restocked with items for purchase and distribution to other customers. In doing so, the inventory management unit 44 maintains a list of inventory items, current quantity levels, minimum and maximum inventory levels, and so on, and tracks inventory levels at multiple WC storage locations. This data can be stored at the LMS 20, or stored at a remote database or other storage repository in communication with the LMS 20. This information may be used to identify a particular WC storage location for receiving certain goods, for example, an ordered item. The inventory management unit 44 may track inventory in one or more retail stores that may in turn provide items of interest to a WC storage location 16 at one or more different locations, for example, to all customers who offer storage space for receipt from a store 14 for resale or distribution to other customers. The LMS 20 may track inventory at the store itself, or other location where the inventory is located. If a consumer is closed to the store 14 than to the WC location 16, then the customer may receive the product from the store 14 instead of from the WC location 16. In some embodiments, the inventory management unit 44 may generate data that directs a user to a location of a product stored as inventory at the WC storage location 16. This feature permits a product to be quickly moved from storage to an NC location 18 who ordered the product.

Some items temporarily stored at the WC storage location 16 has a shelf life. For these inventory items, expiration date information can be captured and processed. For example, a scanner may retrieve an expiration date of the product, and provide it to the inventory management unit 44. The inventory management unit 44 may update or account for the expiration of a product, and update inventory levels accordingly. The inventory management unit 44 may determine whether items at a back of the storage location 16 should be moved to the front of the storage location 16. The LMS 20 may communicate with a camera or other sensor at the WC location 16 that ensures or confirms such inventory rotation. In other embodiments, a camera or sensor on a smartphone or related mobile device, such as head-mounted optical glasses, may capture inventory details, for example, confirming that inventory is rotate, and provide this data to the LMS 20 for processing. The LMS 20 may determine where items are physically location by video recognition, triangulation of RFID tags on the items, or other known techniques. Shelf life dates may be revised when products are swapped in this manner.

In some embodiments, the LMS 20 tracks the physical movement of inventory for the WC storage location 16. Items that are not moving, due to lack of sales or other reason may be identified as a return to the store 14 or other place of origin. In some embodiments, items are returned from the NC location 18 to the WC storage location 16. Items to be returned can be collected during a delivery of other items to the WC storage location 16, or returned by the WC who may ship the items back to the store 14 or place of origin, or from the NC location 18 who may return items. Items collected in this manner may be verified by a mobile electronic device used by a person delivering items to the WC storage location 16, for example, a driver of the delivery vehicle 19, which may cause the LMS 20 to remove the returned items from an inventory list corresponding to the WC storage location 16. The WC 18 may scan returned items, whereby data on the returned items is provided to the LMS 20.

In some embodiments, the LMS 20 can determine whether inventory drops below a predetermined threshold at the WC storage location 16, and/or from the store 14. The inventory management unit 44 can trigger a replenishment order, which is generated and output from the order processor 52 of the LMS 20 to an order processing system, for example, at the store 14. As inventory arrives at the WC storage location 16, a user at the storage location 16 can use a mobile electronic device, laptop computer, or other computer-based device to acknowledge receipt of the order, and to generate an acknowledgement that is sent to the LMS 20, in particular, the order processor 52 of the LMS 20, indicating that the order is received. The LMS 20 can update an inventory list accordingly. In some embodiments, the order processor 52 may communicate with a point of sale (POS) system of the like for processing customer orders. For example, the order processor 52 may communicate with a POS for receiving customer order information for updating a data record that includes data on the inventory. In some embodiments, the order processor 52 may communicate with the inventory management unit 44 to determine which WC storage location among a plurality of WC storage locations has an item of interest for fulfilling an order.

In some embodiments, the goods status monitor 50 can update an inventory list if a determination is made of a product recall, damaged inventory items, identified returns, or other situations that may cause a change in inventory levels. Product recall information may be received and processed by the goods status monitor 50, which can notify the WC of a recall, for example, via an electronic communication such as an email message, and impacts on inventory based on the recall. Recalled products can be collected by a delivery truck 20, similar to returns described above. In addition to recalls, the goods status monitor 50 can establish whether returns or the like are warranted. As described above, the LMS 20 may track inventory. In doing so, expiration dates, recall notices, and the like may be tracked. The LMS 20 may automatically notify the WC with recalled items in the inventory located at the WC location 16.

The reputation integrity management system 46 performs integrity checks for the WC location. The reputation integrity management system can perform social personal profiling, using for example, social media, performing background checks, credit checks, and so on. Goods may also or alternatively be protected by a back ground check to ensure security, video analytics, and so on. This feature can establish the WC's character based of social interactions, daily habits, and so on with respect to the WC.

The agent onboarding engine 48 can ensure vendor/agent selection by using the social profiling, background, or credit check results produced by the reputation integrity management system, and validate the WC through related web services. The agent onboarding engine 48 can gather all information from public areas, for example, from social media websites or other Internet locations, along with an official credit check and background check.

When a WC first signs up, the WC may enter personal data. The required data is then used by the system to run automatic security checks with other 3rd party systems through API calls. The results are analyzed to determine if a WC is a security risk. If all results come back clean, then the WC is accepted. Once the potential WC signs up the must allow an authority such as a store retaining the services of the WC to run all of these checks to ensure that product is managed by a WC having integrity.

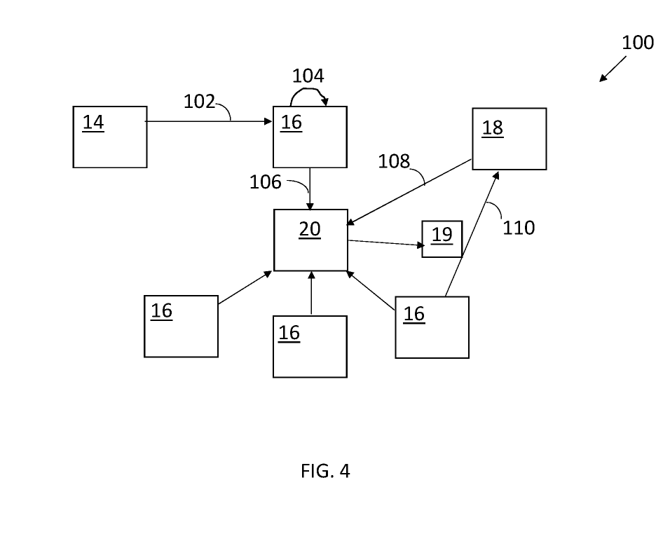

FIG. 4 is a diagram illustrating a method 10 for delivering goods to a consumer's location, in accordance with some embodiments. Some or all of the method 100 can be performed by elements of the environment illustrated in FIG. 1. The method 100 can be governed by instructions that are stored in one or more memory devices of electronic devices of the environment of FIG. 1, and executed by one or more hardware processors of the environment 10 illustrated in FIG. 1.

Prior to performing the method, products of interest to be provided to NC location 18 are delivered according to a retail supply chain, which includes a network of companies including suppliers, manufacturers, and retailers, which produce or distribute the products. In method 100, a retailer may be a store 14, or other source for providing products to the WC storage location 16. In accordance with some embodiments, the method 100 may include crowdsourcing concepts in order to deliver the products quickly and efficiently to the consumer. In some embodiments, if the new customer 18 is within a predetermined distance from the WC location 16, a third party source may deliver goods ordered by the new customer 18 from the WC storage location 16 to the new customer 18. However, if the new customer 18 is closed to a store 14, then the third party driver can deliver the goods from the store 14 to the new customer 18.

Goods are delivered (102) from the store 14 or other source to the WC storage location 16, which processes (104) the received goods, for example, stores details regarding the goods.

Inventory levels or related data is output (106) from each WC storage location 16 to the LMS 20, permitting the LMS 20 to track inventory levels at all WC storage locations 16.

A consumer at an NC location 18 may order an item of interest, for example, by communicating with the store 14, e-commerce site, or other retail establishment offering the item of interest for purchase. The request is received (108) by the LMS 20, in particular by the order processor 52, which can determine which WC storage location 16 has the item in inventory. The LMS 20 can consider other factors, such as the location of the NC location 18 relative to the WC storage location 16.

After the inventory items are identified (108), a delivery provider may be contacted (110) to deliver the identified inventory items from the identified WC storage location 16 to the NC location 18, for example, using a vehicle 19 to deliver the items shown in FIG. 1. In some embodiments, the deliverer may be a person at the WC location 16. In other embodiments, the NC order is made to multiple WC locations 16. Here, several people may deliver various items of an order to the NC location 18, or a single person at one representative WC location 16 may retrieve the other items from the other WC locations 16 and deliver them to the NC location 18. When inventory is removed from an appliance, a communication may be established between the appliance and the device manager 42 of the LMS 20 data that permits the inventory management unit 44 to track the inventory level of goods held in the appliance.

In some embodiments, the delivery person may remove stock from the appliances holding inventory, for example, in cases where items are recalled, expired, damaged, or otherwise unfit for sale to a consumer. Here, the device agents 34 may communicate to the device manager 42 of the LMS 20 data that permits the inventory management unit 44 to track the inventory level of goods held in the appliances.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

what is claimed is:

1. A system for purchasable item delivery, comprising:
an electronic device at a storage area of a first store customer wherein items purchased by the first store customer are temporarily stored after receipt from a retail establishment, and are available for purchase from the first store customer by a second store customer, the electronic device collecting data regarding the items; and
a last mile system that processes the data to track an inventory of the items, and determines whether an item in the inventory of items is available for the second store customer from the storage area of the first store customer; wherein the last mile system comprises:
a device manager that monitors a location of the items at the at least one storage area; and
an inventory management unit that monitors an inventory of the stored items at least at one of the at least one storage area of the first store customer or at the retail establishment.

2. The system of claim 1, wherein the items include RFID devices that relay off beacon readers positioned in the at least one storage area for tracking the items.

3. The system of claim 1, wherein the inventory management unit processes data regarding shelf life, inventory movement, replenishment, recalls, and/or returns to track the inventory of the purchasable items in the at least one storage area of the first store customer.

4. The system of claim 1, wherein the inventory management unit comprises a scanner for detecting a stock of the items as part of the inventory.

5. The system of claim 1, wherein the last mile system comprises:
a reputation integrity management system that performs an integrity check with respect to the first store customer;
an agent onboarding engine that uses at least one of a social profile, background check, or credit check to validate the integrity of the first store customer;
a goods status monitor that updates a list of inventory at the storage area if a determination is made of a product recall, damaged inventory items, identified returns, or other situations that may cause a change in inventory levels; and
an order processor that generates a replenishment order when the inventory drops below a predetermined threshold at the storage area or the retail establishment.

6. The system of claim 5, wherein the reputation integrity management system performs social personal profiling.

7. The system of claim 5, wherein the items are protected by a background check or video analytics.

8. The system of claim 5, wherein the agent onboarding engine ensures selection of the first store customer by using the social profiling, background, or credit check results produced by the reputation integrity management system, and validating the first store customer through related web services.

9. The system of claim 5, wherein the order processor communicates with a point of sale (POS) system for receiving customer order information for updating a data record that includes data on the inventory.

10. The system of claim 5, wherein the order processor communicates with an inventory management unit to determine which storage location among a plurality of storage locations has an item of interest for fulfilling an order.

11. The system of claim 1, wherein the second store customer is downstream in a retail supply chain from the first store customer.

12. The system of claim 1, wherein a first portion of the inventory of the items is for the first store customer and a second portion of the inventory of the items is for the second store customer.

13. The system of claim 1, wherein the first and second store customers are each store customers, and wherein the first store customer does not purchase items at the store for resale to the second store customer.

14. The system of claim 1, wherein the at least one storage area comprises at least one appliance for at least one of storing, maintaining, or dispensing the items for the second store customer, and the electronic device collects data from the at least one appliance.

15. The system of claim 14, wherein the at least one appliance communicates with an inventory management unit regarding inventory usage and restocking.

16. The system of claim 14, wherein the at least one storage area includes at least one of a freezer unit, a cooling unit, or a heating unit, or other device controlling an ambient temperature.

17. The system of claim 1, wherein the inventory or purchasable items in the at least one storage area of the first store customer is consumed by a combination of the first store customer and the second store customer.

18. A system for managing a delivery of goods to a consumer in a final stage of a supply chain, comprising:
an inventory management unit that monitors an inventory of items stored at a storage area of a first store customer or at a retail establishment providing the inventory of items to the first store customer, and determines whether an item in the inventory of items is available for a second store customer from the storage area of the first store customer;
a goods status monitor that updates a list of inventory at the storage area if a determination is made of a product recall, damaged inventory items, identified returns, or other situations that may cause a change in inventory levels; and
an order processor that generates a replenishment order when the inventory drops below a predetermined threshold at the storage area or the retail establishment.

19. The system of claim 18, further comprising a device manager that tracks and locates the items in or proximal the storage area of the first customer.

20. The system of claim 19, wherein the device manager includes an Internet of Things (IoT) device.

21. The system of claim 19, further comprising:
a reputation integrity management system that performs an integrity check with respect to the first store customer; and
an agent onboarding engine that uses at least one of a social profile, background check, or credit check to validate the integrity of the first store customer.

22. A method for delivering store items to a customer, comprising:
storing an inventory of purchasable items at a plurality of warehousing customer locations, each warehousing customer location receiving store items from a store;
monitoring by an electronic device at the warehousing customer location in communication with a last mile system that determines availability and viability of the items;
receiving an order for a store item from a new customer;
determining a closest warehousing customer location; and
delivering the store item from the closest warehousing customer location to the new customer.

23. The method of claim 22, further comprising contacting a delivery provider to deliver the identified inventory items from an identified storage location to the new customer.
